(19) United States
(12) Patent Application Publication
(10) Pub. No.: US 2010/0135807 A1
(43) Pub. Date: Jun. 3, 2010

(54) AN APPARATUS FOR OSCILLATING AND ORIENTING A VANE RELATIVE TO A FLUID

(76) Inventor: Marc Paish, Hull (GB)

Correspondence Address: HOWARD & HOWARD ATTORNEYS PLLC, 450 West Fourth Street, Royal Oak, MI, 48067, US

(21) Appl. No.: 12/513,002

(22) PCT Filed: Oct. 26, 2007
(86) PCT No.: PCT/GB2007/004081

§ 371 Date: Feb. 5, 2010

(30) Foreign Application Priority Data
Oct. 31, 2006 (GB) 0621628.7

(51) Int. Cl. B63H 1/30; F03B 17/06; F03D 5/06

(52) U.S. Cl. 416/147

(57) ABSTRACT

An apparatus for oscillating and orienting a vane (2) relative to a fluid, comprising a main lever (32) pivotally connected at one end about a reference axis (4); a vane pivotally connected to the main lever about a vane axis (6) remote from the reference axis, the vane axis being substantially parallel to the reference axis; a main drive means for oscillating the main lever about the reference axis so displacing the vane from side to side; an angle change assembly (7) for pivoting the vane about the vane-axis comprising (i) an angle drive means adapted to oscillate with a phase lag of approximately 90 degrees to the main drive means; (ii) control means connected between the angle drive means and vane adapted to convert the oscillation of the angle drive means to oscillation of the vane about the vane axis; and, (iii) an offset means adapted to add an offset to the centre of angular oscillation of the vane about the vane axis.

The present invention relates to an apparatus for oscillating and orienting a vane relative to a fluid. More particularly, but not exclusively, the present invention relates to an apparatus for oscillating and orienting a vane relative to a fluid comprising a first mechanism for oscillating the vane and a second mechanism for orienting the centre of oscillation independently of the first mechanism.

Several propulsion mechanisms using oscillating hydrofoils are known. These systems generally use two oscillations which are generally out of phase by approximately 90 degrees. One oscillation drives the displacement of the foil, and the other controls its pitch. Such a mechanism is described in, for example, PCT/FR03/00183 (Chatelan). The different means of transferring these oscillations into foil motion and pitch result in systems with subtly different efficiencies, none however include a means of orienting these foils independently of their oscillation, in order to allow their use as a rudder as well as propellers.

Accordingly, the present invention provides an apparatus for oscillating and orienting a vane relative to a fluid, comprising
a main lever pivotally connected at one end about a reference axis;
a vane pivotally connected to the main lever about a vane axis remote from the reference axis, the vane axis being substantially parallel to the reference axis;
a main drive means for oscillating the main lever about the reference axis so displacing the vane from side to side; and,
an angle change assembly for pivoting the vane about the vane axis comprising
(i) an angle drive means adapted to oscillate with a phase lag of approximately 90 degrees to the main drive means;
(ii) control means connected between the angle drive means and vane adapted to convert the oscillation of the angle drive means to oscillation of the vane about the vane axis; and,
(iii) an offset means adapted to adjust the control means so as to add an offset to the centre of angular oscillation of the vane about the vane axis.

Preferably, the offset means is adapted to be displaced relative to the reference axis;

the control means comprises a second linkage extending between the vane and the offset means and a first linkage extending from the second linkage to the angle drive means; and,
the offset means is coupled to the first and second linkages such that displacement of the offset means displaces the second linkage so rotating the vane about the vane axis.

The vane can comprise a conversion means adapted to convert linear motion of the second linkage means to angular displacement of the vane about the vane axis.

The conversion means can comprise a plate pivotally connected to the vane axis, the second linkage being connected to the plate remote from the vane axis.

The second linkage can comprise a rod.

Alternatively, the second linkage can comprise a cable.

The first linkage can comprise a cable.

Preferably, at least a portion of the cable passes through a flexible tube connected between offset means and a fixed point relative to the reference axis.

The flexible tube can be connected between the offset means and a fixed frame which supports the reference axis.

Preferably, the first and second linkages are separate portions of the same cable.

The apparatus can further comprise a tensioning means adapted to apply a pivoting force to the vane to keep the second linkage under tension.

The apparatus can comprise a plurality of control means.

In a further aspect of the invention there is provided an apparatus for oscillating and orienting a vane relative to a fluid, comprising

a main lever pivoted at one end about a reference axis and pivotally coupled at the other end to the vane about a vane axis, the vane axis being substantially orthogonal to the flow direction;
a drive means for oscillating the main lever and hence the vane substantially laterally from side to side across the direction of motion;
an angle change assembly for oscillating pitch of the foil about its axis, and simultaneously altering the central point of the oscillation to provide directional thrust, comprising:
an angle drive means which oscillates with a phase lag of approximately 90 degrees to the main drive means;
a control cable comprising a variable input length, a mobile section and a variable output length, which is connected so that the oscillating angle drive means causes an oscillating change in the variable input length;
a form with an arc shaped perimeter, centered on the main lever pivot which the mobile length of cable ends and the variable output length begins, and around which the beginning of variable output length is held under tension;
a form attached to the vane and with an arc shaped perimeter centered on the vane axis, around which the variable output length is held under tension and onto which the terminus of the cable is attached so that the change in the distance of the cable terminus from the main lever pivot results in a change in the angle of the form and hence the vane;
a tensioning device which maintains the cable under tension by pulling the form in the opposite direction to the cable;
a means for changing the angular position of the form, thereby moving both the beginning and end of the variable output length of cable, thus providing a means of changing the pitch of the vane, independent of the oscillation caused by the angle drive means.

The present invention will now be described by way of example only and not I any limitative sense with reference to the accompanying drawings in which

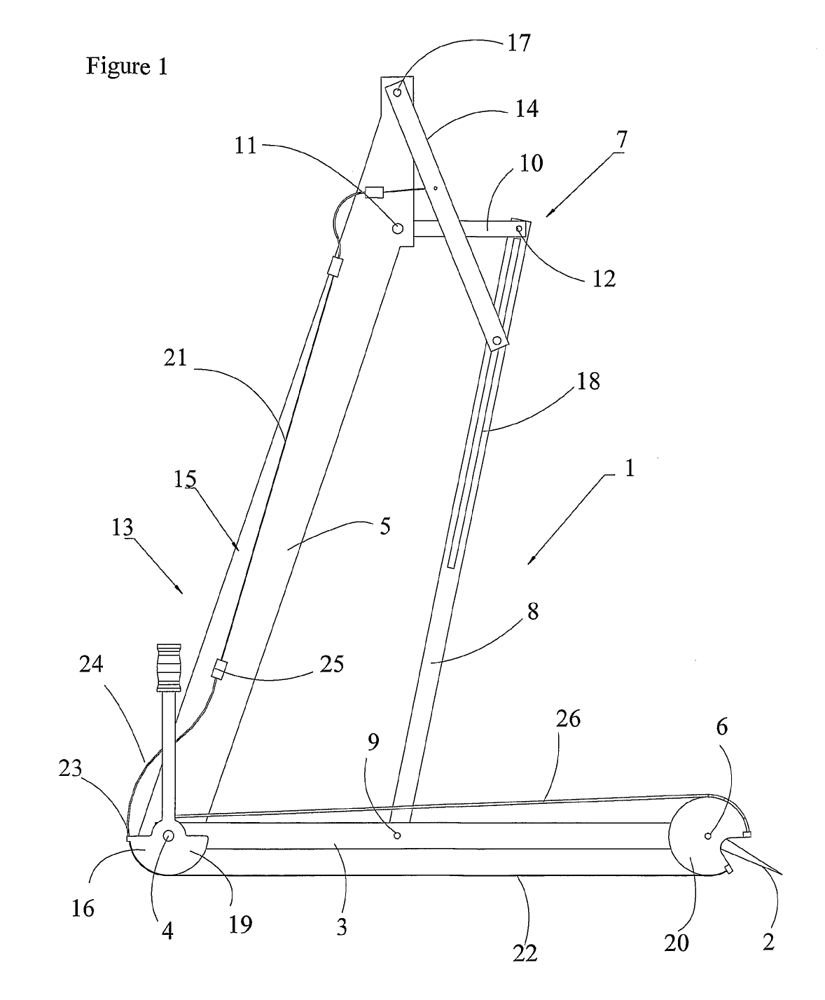

FIG. 1 shows a first embodiment of the invention; and,

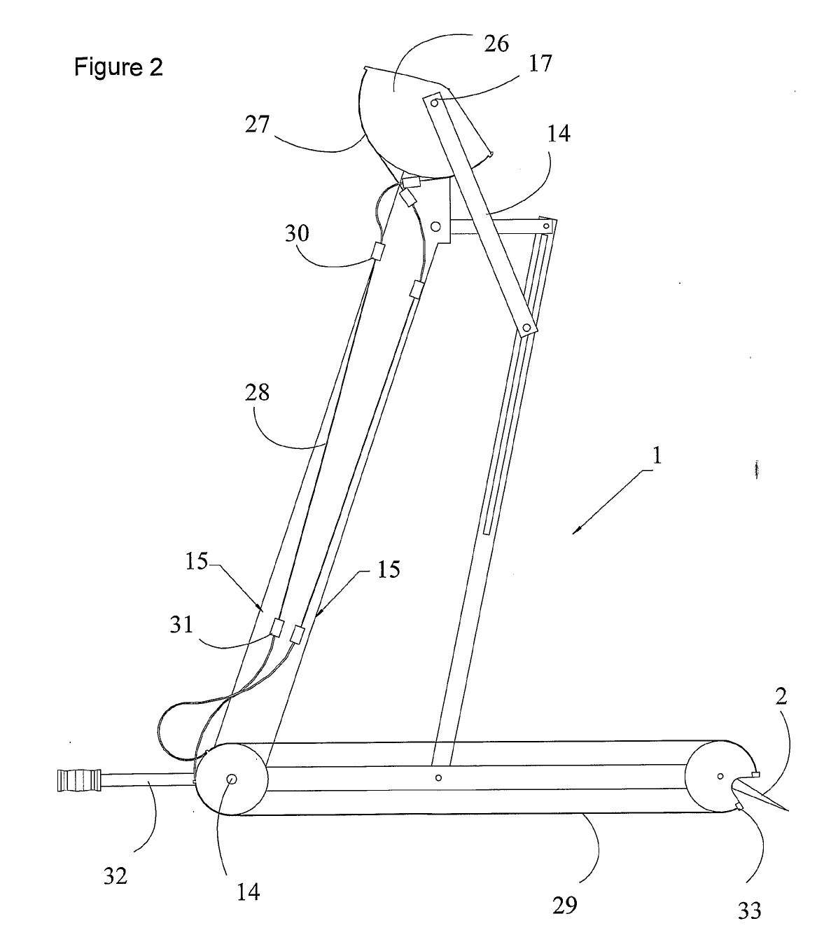

FIG. 2 shows a second embodiment of the invention.

FIG. 1 shows an apparatus 1 for oscillating and orienting a vane 2 relative to a fluid (not shown) according to the invention. The apparatus 1 comprises a main lever 3 pivotally connected at one end about a reference axis 4 which is connected to a fixed frame 5. The vane 2 is pivotally connected to the other end of the main lever 3 about a vane axis 6. The vane axis 6 and reference axis 4 are substantially parallel.

The apparatus 1 further comprises a main drive means 7. The main drive means comprises a first drive arm 8 connected to the main lever 3 remote from the reference axis 4 at a connection point 9 and a second drive arm 10 connected to a fixed axis 11. The first and second drive arms 8,10 are pivotally connected together at pivot 12.

The apparatus 1 further comprises an angle change assembly 13 for pivoting the vane 2 about the vane axis 6. The angle change assembly 13 comprises an angle drive means 14, control means 15 and an offset means 16.

The angle drive means 14 is connected between a fixed pivot 17 and first drive arm 8. The end of the angle drive means 14 connected to the first drive arm 8 is adapted to slide along a slot or groove 18 in the first drive arm 8 as shown.

The offset means 16 is connected to the reference axis 4 and in this embodiment comprises a portion of a disk 19 as shown. The offset means 16 can be pivoted about the reference axis 4 independently of the main lever 3 and fixed frame 5. Once in the desired position the offset means 16 can be locked in position.

The vane 2 comprises a conversion means 20 pivoted about the vane axis 6. Pivoting of the conversion means 20 pivots the vane 2 about the vane axis 2. In this embodiment the conversion means 20 is a disk.

The control means 15 comprises first and second linkages 21,22. The second linkage 22 comprises a cable. One end of the cable is connected to the conversion means 20 remote from the vane axis 6. The other end of the cable extends around the outer edge of the disk 19 of the offset means 16 to an end point 23. The first linkage 21 also comprises a cable extending from the end point 23 to the angle drive means 14. In this embodiment the first and second linkages 21,22 are different portions of the same cable. Part of the first linkage 21 passes through a tube 24 which extends from the end point 23 to a fixed point 25 on the fixed frame 5.

A tensioning means 26 is connected between the conversion means 20 and the fixed frame 5. The tensioning means 26 is connected to the conversion means 20 on the opposite side of the vane 2 to the second linkage 22 and pulls the vane 2 in the opposite direction to the second linkage 22 so keeping the second linkage 22 under tension.

In use the second drive arm 10 rotates about the fixed axis 11. The fixed axis 11 is typically driven by a crank (not shown). This displaces the first drive arm 8 causing displacement of the main lever 3 from side to side about the reference axis 4.

Displacement of the first drive arm 8 also causes oscillation of the angle drive means 14 about the fixed axis 17. Displacement of the angle drive means 14 in a first direction causes displacement of the first linkage 21 connected thereto towards the end point 23. This in turn causes displacement of the second linkage 22 towards the vane 2. This linear displacement causes rotation of the conversion means 20, so rotating the vane 2 about the vane axis 6. As the angle drive means 14 pivots in the opposite direction about the fixed axis 17 the process is reversed—the first linkage 21 is displaced away from the end point 23. This in turn displaces the second linkage 22 towards the end point 23 so rotating the vane 2 in the opposite direction about the vane axis 6.

The motion of the vane 2 therefore comprises two components—the side to side motion of the vane axis 6 due to pivoting of the main lever 3 about the reference axis 4 and the side to side pivoting of the vane 2 about the vane axis 6. These two oscillating components are arranged to be substantially 90 degrees out of phase such that when the vane 2 is at an extremity of its side to side displacement it is at its mid point of rotational oscillation about the vane axis 6. This keeps the vane 2 pointing in substantially the same direction into the fluid (not shown).

Rotation of the offset means 16 about the reference axis 4 changes the distance between the end point 23 and the conversion means 20. This causes a corresponding displacement of the second linkage means 22 towards or away from the vane 2 so adding a constant offset to the angular displacement of the vane 2 in addition to the oscillating angular displacement. This enables the apparatus 1 to be steered in the fluid (not shown).

Rotation of the offset means 16 also causes a change in the distance between the endpoint 23 and angle drive means 14.

As can be seen from FIG. 1, the flexible tube 24 is curved slightly. As the offset means 16 is displaced this curvature changes. This effectively lengthens or shortens the first linkage 21 so allowing for this change.

Alternative forms of linkage means 21,22 are possible. For example in an alternative embodiment (not shown) the second linkage 22 comprises a rod, rather than a cable. In this embodiment the tensioning means 26 is not required.

Other forms of linkage means 21,22 are also possible. In all cases displacement of the first linkage means 21 causes a corresponding displacement of the second linkage means 22. Displacement of the offset means 16 also causes displacement of the second linkage means 22, independent of the displacement of the first linkage means 21.

In an alternative embodiment of the invention (not shown), at least one of the linkage means 21,22 is hydraulic.

Shown in FIG. 2 is a further embodiment 1 of the invention. The embodiment 1 of FIG. 2 is similar to that of FIG. 1 except it comprises two control means 15 adapted to rotate the vane 2 in opposite directions as shown. In this embodiment the angle drive means 14 comprises a semicircular end portion 26 to which the control means 15 are attached. The control means 15 are arranged to act co-operatively as shown.

An alternative way of describing the invention is as follows, wherein like parts are referred to by like reference numerals—

The present invention concerns the angle change assembly 13. This assembly 13 comprises:
An angle drive means 14 for oscillating the angle change assembly 13 with a phase lag of 90 degrees relative to the main drive means 7.
A cable 15 which can be considered to have a beginning, which is attached to the angle drive means 14 and an end which is indirectly connected to the vane 2. The cable 15 can be considered as comprising three functionally distinct sections:
   1. The variable input length 27, the beginning of which is connected to the angle drive means 14, the end of which enters the mobile section 28. The mechanism varies the length of this section 27 in order to control what occurs at the opposite end.
   2. The mobile section 28, the beginning of which is near the angle drive means 14, and the end of which is near the vane 2. Either end of the mobile section 28 can be moved without changing its length.
   3. The variable output length 29, the beginning of which is where the cable 15 exits the mobile section 28, and the end of which is indirectly connected to the vane 2. If the length of the mobile section 28 is held constant, a lengthening of the input variable length 27 of the cable 15 will result in a shortening of the output variable length 29 and vice versa.
A fixed reference frame 5 to which is held the mobile length 28 of cable 15 by connections 30,31;
A semi circular main pivot form 19, centred on the pivot 4 of the main lever 3, on which is positioned the end of the fixed length of cable, and around which is laid the beginning of the variable output length 29;
A semi circular vane form 20, fixed to the vane axis 6, onto which is positioned the terminus of the variable output length 29, and around which is laid the end of the variable output length 29; and,
A means 26 of tensioning the output variable length 22 by pulling the vane 2 form in the opposite direction to the cable 15.

The variable in the mechanism which determines the angle of the foil 2 is the distance of the terminus of the variable output length 29, from the pivot 4 of the main lever 3.

This distance can be altered independently in the following ways:
changing the variable output length 29 by changing the variable input length 27;
changing the variable output length 29 by changing the mobile length 28; and,
moving the beginning of the variable output length 29

The mechanism therefore provides three independent means for changing the pitch of the vane 2. One of these can be used to oscillate the pitch in order to produce a propulsive effect; either of the remaining two can be used to orientate the foils.

The foil pitch is oscillated by the following means:

The variable input length 27 of cable 15 is determined by the angle drive means 14. The angle drive means 14 provides a sinusoidal oscillation which is approximately 90 degrees out of phase with the main drive means 7 which causes the vane 2 to move from side to side. This oscillation results in a roughly sinusoidal change in the variable input length and a corresponding inverted change in the variable output length 29.

FIG. 1 shows an apparatus 1 which can be used to simultaneously oscillate and orientate a vane 2 within a fluid. The apparatus comprises a vane 2 pivotally coupled to the end of a main lever 3. The main lever 3 is pivotally coupled to a reference axis 4. The main lever 3 is connected to a main drive means 7 which in this case is a crank and connecting rod arranged in order that a rotation in the main drive means 7 will result in an oscillation of the main lever 3 and hence the vane 2.

An angle drive means 14 creates an oscillation which is approximately 90 degrees out of phase with that created by the main drive 7. The control cable 15 is attached to the angle drive means 14. The start of the mobile length 28 of the cable 15 is positioned in order that a change in position of the angle drive means 14 results in a change in the variable input length 27 of the cable 15.

The control cable 15 passes into an outer sheath 24. This allows the ends of the mobile section 28 of cable 15 to be moved without changing its length. This mobile section 28 of cable 15 continues to point 23, which is on the semi circular main pivot form 19. The semi circular main pivot form 19 is centred on the pivot 4 of the main lever 3, and its angular position is determined by the positioning means 32. From point 23 the control cable 15 follows the circumference of the semi circular main pivot form 19, which it leaves tangentially to meet the circumference of semicircular vane form 20, where it is attached at point 33. The part of the control cable 15 between points 23 and 33 is the variable output length 29.

The cable 15 is held under tension by a tensioning device 26 which pulls the semicircular vane form 20 in an opposite direction to the cable 15.

As the main drive means 7 turns, the angle drive means 14 will continually vary the variable input length 27 in an approximately sinusoidal oscillation. This will result in an approximately sinusoidal change in the variable input length 27, and hence the variable output length 29. The change in the variable output length 18c will result in an oscillation in the pitch of the vane 2. This oscillation, when combined with the lateral oscillation of the vane 2 results in a propulsive effect.

A movement in the positioning device 32 will result in a tangential movement around the main pivot 4 of the end of the mobile length 28 of cable 15, and therefore of the beginning of the output variable length 29. This will result in a change in the position of the end of the output variable length 29, and thus a change in the angle of the vane 2. This movement would shift the position of the centre of the pitch oscillation, resulting in and an orientation of the thrust.

Two further adjustments which would have the same effect of shifting the direction of thrust are as follows:

A change in the position of the start of the mobile length 28, which has the effect of changing the length of the variable input length 27.
A change in the position of either connections 30,31 which has the effect of changing the overall length of the mobile length 28 of cable 15.

Shown in FIG. 2 is an apparatus 1 according to a further embodiment of the invention. In this apparatus, the tensioning device 26 comprises a second control cable 15 which operates in opposition to the first.

This is achieved by incorporating a form of fixed radius 26 onto the angle drive means 14, the centre of the radius being the pivot point 17 of this form 26. The input variable length 27 of first and second control cables 15 are attached at points on this form 26 in such a way that a change in angular position of the angle drive means 14, results in a lengthening of one input variable length 27 which is equal to the shortening of the other.

The changes in input variable length 27 are transferred into changes in output variable length 29, and hence changes in the angular position of the vane 2, as described in FIG. 1. Such an apparatus results in a greater degree of control over the angle of the vane 2.

1. An apparatus for oscillating and orienting a vane relative to a fluid, comprising:
a main lever pivotally connected at one end about a reference axis;
a vane pivotally connected to the main lever about a vane axis remote from the reference axis, the vane axis being substantially parallel to the reference axis;
a main drive means for oscillating the main lever about the reference axis so displacing the vane from side to side; and
an angle change assembly for pivoting the vane about the vane axis comprising
(i) an angle drive means adapted to oscillate with a phase lag of approximately 90 degrees to the main drive means;
(ii) control means connected between the angle drive means and vane adapted to convert the oscillation of the angle drive means to oscillation of the vane about the vane axis; and
(iii) an offset means adapted to adjust the control means so as to add an offset to a centre of angular oscillation of the vane about the vane axis.

2. An apparatus as claimed in claim 1, wherein the offset means is adapted to be displaced relative to the reference axis; the control means comprising a second linkage extending between the vane and the offset means and a first linkage extending from the second linkage to the angle drive means; the offset means being coupled to the first and second linkages such that displacement of the offset means displaces the second linkage so rotating the vane about the vane axis.

3. An apparatus as claimed in claim 2, wherein the vane comprises a conversion means adapted to convert linear motion of the second linkage means to angular displacement of the vane about the vane axis.

4. An apparatus as claimed in claim 3, wherein the conversion means comprises a plate pivotally connected to the vane axis, the second linkage being connected to the plate remote from the vane axis.

5. An apparatus as claimed in claim 4, wherein the second linkage comprises a rod.

6. An apparatus as claimed in claim 4, wherein the second linkage comprises a cable.

7. An apparatus as claimed in claim 6, wherein the first linkage comprises a cable.

8. An apparatus as claimed in claim 7, wherein at least a portion of the cable passes through a flexible tube connected between offset means an a fixed point relative to the reference axis.

9. An apparatus as claimed in claim 8, wherein the flexible tube is connected between the offset means and a fixed frame which supports the reference axis.

10. An apparatus as claimed in claim 9, wherein the first and second linkages are separate portions of the same cable.

11. An apparatus as claimed in claim 10, further comprising a tensioning means adapted to apply a pivoting force to the vane to keep the second linkage under tension.

12. An apparatus as claimed in claim 11, comprising a plurality of control means.

13. An apparatus for oscillating and orienting a vane relative to a fluid, comprising:
a main lever pivoted at one end about a reference axis and pivotally coupled at the other end to the vane about a vane axis, the vane axis being substantially orthogonal to the flow direction;
a drive means for oscillating the main lever and hence the vane substantially laterally from side to side across the direction of motion;
an angle change assembly for oscillating a pitch of a foil about its axis, and simultaneously altering a central point of the oscillation to provide directional thrust, comprising:
an angle drive means which oscillates with a phase lag of approximately 90 degrees to the main drive means;
a control cable comprising a variable input length, a mobile section and a variable output length, which is connected so that the oscillating angle drive means causes an oscillating change in the variable input length;
a main pivot form with an arc shaped perimeter centered on a main lever pivot on which the mobile section of the cable ends and the variable output length begins and around which a beginning of the variable output length is held under tension;
a vane form attached to the vain with an arc shaped perimeter centered on the vane axis around which the variable output length is held under tension and onto which a terminus of the cable is attached so that a change in the distance of the cable terminus from the main lever pivot results in a change in an angle of the vane form and hence the vane;
a tensioning device which maintains the cable under tension by pulling the vane form in the opposite direction to the cable;
a means for changing an angular position of the forms, thereby moving both the beginning and an end of the variable output length of the cable, thus providing a means of changing a pitch of the vane independent of the oscillation caused by the angle drive means.
